(19) United States
(12) Patent Application Publication
(10) Pub. No.: US 2003/0099796 A1
(43) Pub. Date: May 29, 2003

(54) Flexible intermediate bulk container with multiple conductive fibers having permanent anti-static effect

(75) Inventor: Avram Levi, Istanbul (TR)

Correspondence Address: John S. Egbert, Harrison & Egbert, 7th Floor, 412 Main Street, Houston, TX, 77002, US

(73) Assignee: SUNJUT SUNI JUT SANAYI VE TIC. A.S., Umraniye (TR)

(21) Appl. No.: 10/120,259

(22) Filed: Apr. 11, 2002

(30) Foreign Application Priority Data
Nov. 28, 2001 (TR) 2001/03444

(51) Int. Cl. B32B 1/02

(52) U.S. Cl. 428/36.1

(57) ABSTRACT

The present invention relates to flexible intermediate bulk container (FIBC), particularly relates to FIBC (“big bag” as called in trade) fabric having permanent anti-static-treated fibers for dissipation of static electricity charged on the FIBC.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to flexible intermediate bulk container (FIBC), particularly relates to FIBC (“big bag” as called in trade) fabric having permanent anti-static-treated fibers for dissipating static electricity charged on the FIBC.

### BACKGROUND OF THE INVENTION

Flexible intermediate bulk containers, so called FIBCs, are widely used for transporting powders and bulk solids. Despite FIBCs many advantages in storage and transport, electrostatic discharges generated during the filling and emptying of the FIBCs present an ongoing problem. Contact electrification results in electrostatic charge and surface potential increase can lead to electrostatic discharge from the bag.

Static discharges could be an effective ignition source and explosion may occur in the presence of ignitable atmosphere such as gas, vapor, mist or dust. In addition, static discharge poses a problem for the use of FIBCs in packaging potentially explosive.

There have been several attempts by FIBCs manufacturers to overcome this problem. One of these solutions is using conductive groundable bags which are made of standard polypropylene (PP) fabrics woven with addition of conductive threads in both weft and warp directions. The conductive threads are made of PP, compounded with carbon black or silver coated (silver vaporized) multifilament threads. Electrostatic charge that accumulates on the surface of the bag is safely transmitted to the ground via conductive threads.

Another idea has been to use a dissipative bag (Type D bag) such that electric charges will be discharged from the bag surface by corona discharge without the need of grounding.

Another structure, in the relevant technical field, is attributed to FIBC made of antistatic treated and/or laminated fabric for homogeneously distributing the static electricity thereof. By this structure, the static electricity on the fabric is discharged by means of anti-static fibers to the atmosphere, so called as corona effect, of the FIBC. In this structure, conducting the static electricity is achieved by anti-static-treated fibers functioning in accordance with the migration effect. This leads to incapability of the conductivity functions of the structure, since the anti-static effect diminishes with various external effects such as cleaning, washing and so on.

The aforementioned proposals bear considerable advantageous impacts for eliminating the static electricity from the fabric material of FIBCs, however, some structural deficiencies cause some disadvantages for solving the problem underlying the relevant technical field.

For instance, particularly the above-mentioned second structure, since the additive materials are not permanent based, anti-static effect would not a reliable solution for the problem experienced. Indeed, the effect of the structure decreases with cleaning, washing etc. of the FIBC.

Since these FIBC embodiments are based upon migration effect, the character of the material, like fine materials, becomes a significant issue. Since, anti static-treated fibers migrate into the materials charged into the FIBC as migrating to the atmosphere. Consequently, some certain type of chemical-based and nutrition-based materials cannot be charged into the FIBCs.

### BRIEF SUMMARY OF THE INVENTION

The object of the present invention is to dissipate the static electricity accumulated on FIBC to the surrounding atmosphere thereof by permanent anti-static-treated multi-filaments fibers established to the FIBC.

The construction of the present invention is based on a net structure comprising multi-filament fibers formed by gathering many fine fibers on the woven fabric of the FIBC.

Alternatively, the multi-filament fibers can be woven in single weft or warp directions parallel to each other on the fabric.

Each of the singular fibers, gathered to form multi-filament configuration in the scope of the present invention, is obtained by adding recently developed permanent anti-static additives IRGASTAT P18 or IRGASTAT P22 produced by the Ciba Geigy® to the filament material in the preferable ratio of 6% to 20%.

In order to distribute the anti-static effect through the surface of the FIBC fabric uniformly, the outer surface of the fabric of FIBC is covered by a lamination. This lamination is also obtained by adding permanent anti-static additives IRGASTAT P18 or IRGASTAT P22 produced by the Ciba Geigy® to the lamination material in the preferable ratio of 6% to 20%.

Carrying belts Holders (loops) are also containing anti-static treated multi-filaments made with IRGASTAT series additives.

### BRIEF DESCRIPTION OF THE SEVERAL VIEWS OF THE DRAWINGS

The advantage of the structure of the present invention and its auxiliary elements will become better understood from the given detailed figure.

FIG. 1 Perspective view of the permanent anti-static FIBC in accordance with the present invention.

### DETAILED DESCRIPTION OF THE INVENTION

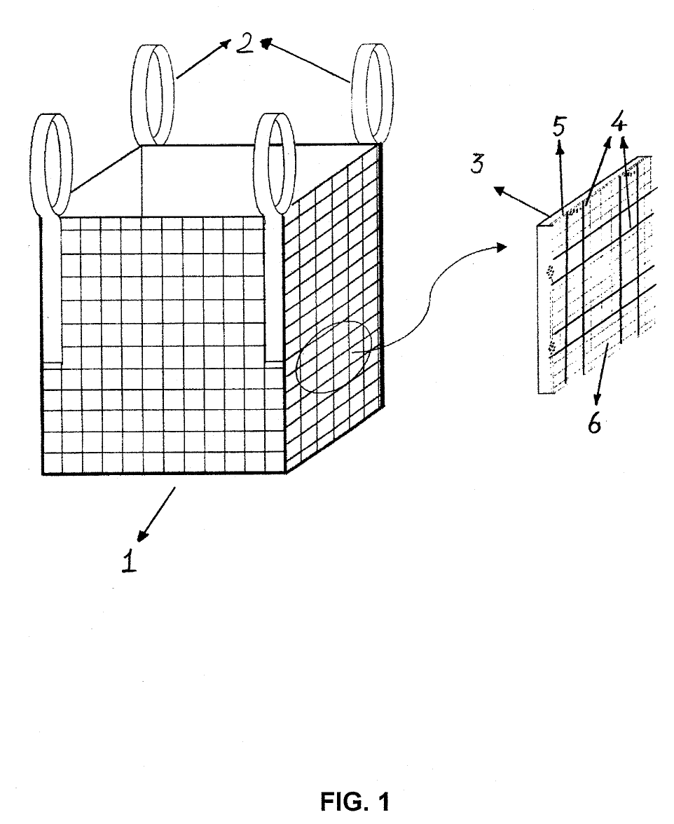

In FIG. 1, a perspective view of the FIBC with permanent anti-static effect is illustrated according to the present invention. The FIBC (1) and a detailed view of lateral side thereof are shown. FIBCs (1) are carried by the holders (loops) (2) placed to the corners.

The fabric (5) can be seen in the detailed view. Multi-filament fibers (4) providing permanent anti-static effect are woven in the fabric (5) among the fabric texture (6).

These permanent anti-static multi-filament fibers, in the scope of the present invention, capable of dissipating static electricity accumulated on the FIBC are obtained by adding permanent anti-static additives IRGASTAT P18 or IRGASTAT P22 produced by the Ciba Geigy® to the filament material in the preferable ratio of 6% to 20%.

The number of mono-filament forming the multi-filaments is preferably 50 to 200 and is between 4 to 20 denier filament.

Permanent anti-static multi-filament fibers according to the present invention, alternatively are formed as mono-filament or tape pattern having permanent anti-static effect by adding permanent anti-static additives IRGASTAT P18 or IRGASTAT P22 produced by the Ciba Geigy® to the filament material in the preferable ratio of 6% to 20%.

Multi-filament or mono-filament fibers (4) having additives IRGASTAT P18 or IRGASTAT P22 are woven to the fabric (5) for forming a net structure therein. However, alternatively, these fibers may be woven to the fabric (5) in single direction i.e. in weft or warp direction as parallel to each other. The distance between the anti-static fibers is preferably 45*45 mm.

In order to distribute the static electricity to the surface of the fabric uniformly, a lamination (3) is embodied to the FIBC fabric. This lamination (3) is also obtained by adding permanent anti-static additives IRGASTAT P 18 or IRGASTAT P22 produced by the Ciba Geigy(g to the lamination material in the preferable ratio of 6% to 20%.

The lamination (3) is preferably placed to the inner surface of the FIBC (1) and the fabric (5) is established on the lamination (3).

Consequently, by means of the present invention the FIBC (1) comprising fabric (5) formed by polymer-based fibers and multi-filament or mono-filament fibers having permanent anti-static additives and lamination (3) formed by the same permanent anti-static additives provides dissipation of static electricity accumulated on the FIBC (1) to the surrounding atmosphere by corona effect i.e. without migration.

I claim:

1. A flexible intermediate bulk container (FIBC) comprising a lamination for distributing static electricity accumulated on fabric of the FIBC to surface of the fabric uniformly and anti-static fibers woven to the fabric for conducting the static electricity to the atmosphere surrounding the FIBC by corona effect the development comprising the lamination (3) having permanent anti-static additives IRGASTAT P18 or IRGASTAT P22 in the preferable ratio of 6% to 20%.

2. A permanent anti-static-treated flexible intermediate bulk container (FIBC) according to claim 1, wherein said anti-static fibers (4) comprises permanent anti-static additives IRGASTAT P18 or IRGASTAT P22 in the preferable ratio of 6% to 20% for dissipating the static electricity.

3. A permanent anti-static-treated flexible intermediate bulk container (FIBC) according to preceding claims, wherein said anti-static fibers (4) comprises multi-filament fibers.

4. A permanent anti-static-treated flexible intermediate bulk container (FIBC) according to preceding claims, wherein number of said filaments forming the multi-filaments (4) is between 50 to 200.

5. A permanent anti-static-treated flexible intermediate bulk container (FIBC) according to preceding claims, wherein said multi-filament fibers (4) are between 4 to 20 denier filament.

6. A permanent anti-static-treated flexible intermediate bulk container (FIBC) according to preceding claims, wherein said anti-static fibers are woven to the fabric (5) for forming a net structure therein or woven to the fabric (5) in single direction i.e. in weft or warp direction as parallel to each other.
